(19) United States
(12) Patent Application Publication
(10) Pub. No.: US 2004/0063475 A1
(43) Pub. Date: Apr. 1, 2004

(54) Wrist mobile phone device having voice activated wireless headset

(76) Inventor: Yuan Sung Weng, Taipei (TW)

Correspondence Address: BUCKNAM AND ARCHER, 1077 Northern Blvd., Roslyn, NY, 11576, US

(21) Appl. No.: 10/639,802

(22) Filed: Aug. 12, 2003

(30) Foreign Application Priority Data
Sep. 26, 2002 (TW) 091215245

(51) Int. Cl. H04M 1/00

(52) U.S. Cl. 455/575.6

(57) ABSTRACT

The present invention provides a wrist mobile phone device having voice activated wireless headset, comprising a mobile phone provided with a wireless headset for conducting send/receive operation of mobile radio communication, which is characterized in that said mobile phone is provided with a put-on device so as to be put on the wrist of user, and said mobile phone is provided with a voice activated device for performing voice dial, accordingly, it is possible to provide the user with convenient mobile send/receive operation of radio communication with the aid of such wrist mobile phone device.

### BACKGROUND OF THE INVENTION

1. Field of the invention

The present invention relates to a wrist mobile phone device having voice activated wireless headset, and especially to a mobile phone device that can be put on the wrist and having the function of voice activation to facilitate the dial operation of such mobile phone.

2. Description of the prior art

Recently, there is rapid development and increasing usage of mobile phone, it is expected to miniature the size of the mobile phone except the progress on its function. However, since conventional mobile phone currently in the market is largely handholding-type, (i) it must be provided with numeral keys for dialing by using a technology of assembling a plurality of integrated circuit, so that it is inconvenient to carry and frequently lost or stolen due to hard to reduce the size; (ii) in order to communicate with the other party using the mobile phone one must keep his mouth close to the microphone and his ear to the speaker, since the mouth-to-ear distance is equal to or larger than about 80 mm, the microphone-to-speaker distance of such handholding mobile phone is restricted to this magnitude; (iii) one must manually dial the phone number to make a phone call, even if currently developed mobile phone or prototype using wire or wireless application such as Bluetooth technology or the newly proposed aspect of wrist mobile phone in the industry have not yet prevented one from the inconvenience of manual operation by both hands.

SONY(Japan) has disclosed in the Japanese patent application JP-A 11-298362 published in Oct. 29, 1999, a compact portable communication terminal that can be put on the wrist to perform communication. However, the disadvantages of manual operation and short distance between coplanar arranged microphone and speaker remain unsolved while the requirement of continuously changing the position of the arm in order to make a phone call may result in further inconvenience.

Furthermore, NOKIA has disclosed in the Japanese patent application JP-A 11-298362 published in Jun. 19, 1998, a mobile-type wrist wireless telephone set that can be put on the wrist to send/receive message and to perform the function of a mobile phone. However, one must carry the main body of the mobile phone incorporated with the associate wrist device, while the send/receive operation of such device has the same disadvantage as the above SONY product.

Since being light, thin and small is the major element of a wrist mobile phone, even if it is possible to remove the problem of short distance between the microphone and speaker, the necessity of raising one's arm to approach his head to such device does not fulfill the requirement of posture technology and may easily cause tiredness in long time use. Therefore, it is necessary to develop a mobile phone device that provides not only carry easiness but also convenient operation so as to meet the need of modern busy life style, i.e., it must be light, thin, and compact device that adapts the ergonomic technology.

### SUMMARY OF THE INVENTION

Therefore, the object of present invention is to provide a wrist mobile phone device having voice activated wireless headset so as to produce an easy to carry device with simple operation.

In one aspect of the present invention, the above object is achieved by a wrist mobile phone device comprises a mobile phone having voice activated wireless headset for conducting mobile send/receive operation of radio communication, which is characterized in that:

said mobile phone is provided with a put-on device so as to be put on the wrist of user, and

said mobile phone is provided with a voice activated device for performing voice dial, accordingly, it is possible to provide the user with convenient mobile send/receive operation of radio communication with the aid of such wrist mobile phone device.

In another aspect of present invention, the wireless headset in above wrist mobile phone device is used to perform wireless sending/receiving messages to/from said mobile phone. In further aspect of present invention, the above wrist mobile phone device is further provided with a digital camera for taking and sending images through said mobile phone.

In still further aspect of present invention, the above wrist mobile phone device is further provided with a liquid crystal display unit for displaying images taken by said mobile phone or receiving from external devices.

Therefore, the wrist mobile phone device in accordance with above aspects of present invention is capable of solving problems encountered in the conventional technology all together.

Heretofore, since the technologies such as semiconductor device miniaturization and system on chip have gradually become matured and stable, it is then possible to turn handholding mobile phone into miniaturized wrist mobile phone device. Furthermore, since the mobile phone watch of present invention allow us to make phone calls by simple voice command such as numbers 0-9 and a couple operation instruction, thus it is possible to complete the voice activation with only one voice activated IC instead of a plurality voice activated ICs in the conventional technology. Therefore, it is possible to place a hands-free phone call with the wrist mobile phone device of present invention.

### BRIEF DESCRIPTION OF THE DRAWINGS

The above and other objects, features, and advantages of present invention will become more apparent from the detailed description in conjunction with the accompanying drawings:

FIG. 1 is a block diagram showing the implementation of an embodiment of present invention.

FIG. 2 is a block diagram schematically showing the structure of the wrist mobile phone device having voice activated wireless headset in accordance with an embodiment of present invention.

FIG. 3 is a block diagram schematically showing the structure of the wireless headset in the wrist mobile phone device of present invention.

FIG. 4 is a schematic view of a product manufactured in accordance with an embodiment of present invention.

### DETAILED DESCRIPTION OF THE INVENTION

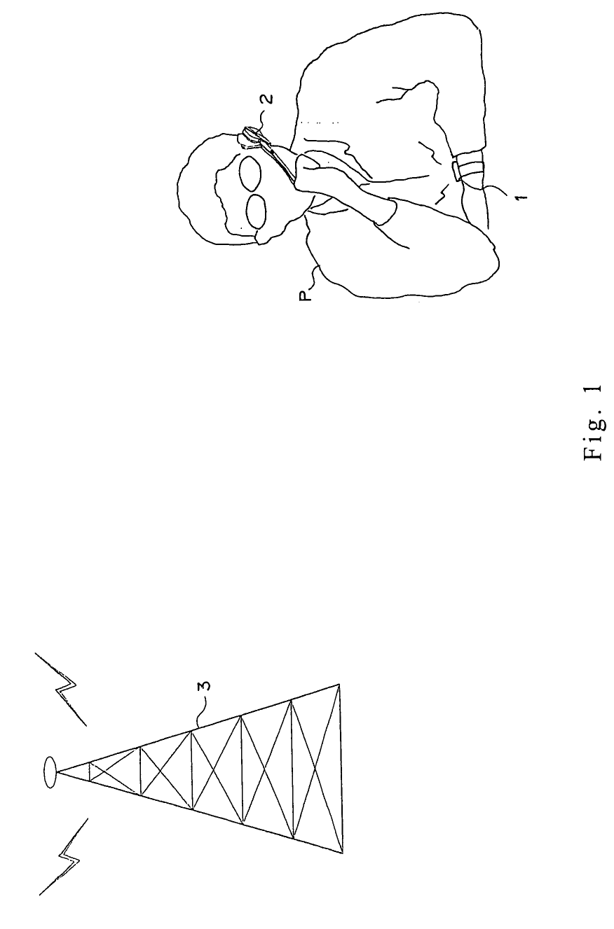

Referred to FIG. 1, a schematic view showing the implementation of an embodiment of present invention. As shown in the figure, user p has put on a wrist mobile phone device having voice activated wireless headset of present invention, in which the user p has on his wrist a mobile phone 1 for sending/receiving messages to/from a base station 3, and on his head a headset 2 for conducting wireless short distance communication with said mobile phone and sending/receiving voice message to/from said base station. In this embodiment, the user p are hands-free and there is no need for him to raise his hand to send/receive voice message through the mobile phone as in prior arts.

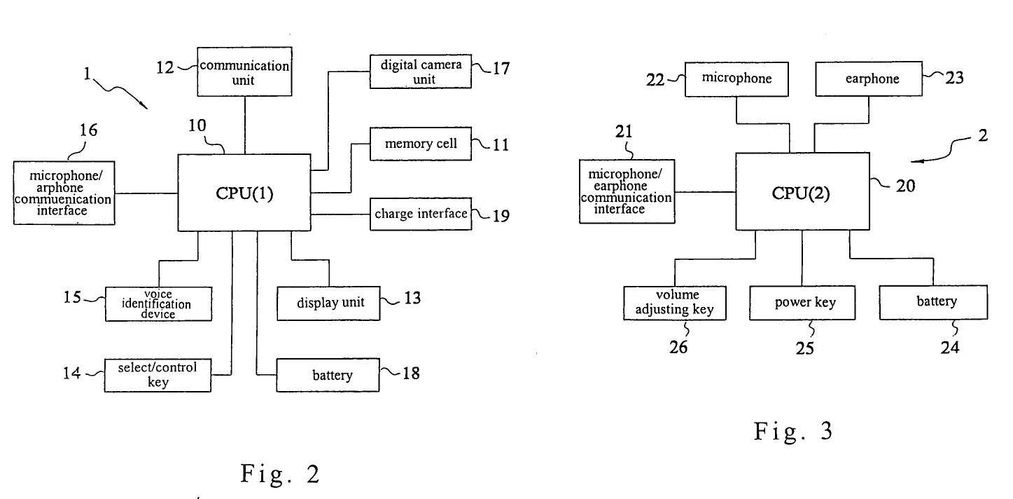

Referred to FIG. 2, a block diagram schematically showing the structure of the wrist mobile phone device having voice activated wireless headset in accordance with an embodiment of present invention. Said wrist mobile phone device comprises a case (not shown) that demarcates an accommodation space therein and fits to the user's wrist via a put-on device. In said accommodation space, there is provided with: a first central processing unit (CPU) 10, for controlling the operation of each member in order to control the communication function of sending/receiving message; a memory cell 11, for storing data including phone numbers and the setting conditions of above sending/receiving operation; a communication unit 12, for conducting the communication function of sending/receiving message; a display unit 3, for displaying data on a liquid crystal display device therein; a select/control key 14, comprising a control key 14a for controlling/setting the communication conditions and a select key 14b for selecting the communication mode/condition; a voice activated device 15, for generating a signal corresponding to each preset voice command, represented as number 0 to 9 and some simple voice code, given by the user and outputting such signal to said first CPU so as to control the operation of associated members, while in case of failed to perform voice activation one can still dial through control key 14a and select key 14b; a first short-distance-type wireless microphone/earphone communication interface 16, for providing wireless interface between said wrist mobile phone device 1 and said wireless headset (no shown); a digital camera unit 17, for taking image with a digital camera therein and sending/receiving image through said communication unit 12 while display received image on said display unit 13; a lithium polymer battery 18; and a charge interface 19, for charging said lithium battery 18 and supplying work voltage to each member.

Subsequently referred to FIG. 3, a block diagram schematically showing the structure of the wireless headset in the wrist mobile phone device of present invention. Said wireless headset 2, which can also be a mini over-the-ear headset, comprises: a second central processing unit 20, for controlling the send/receive operation of members in said wireless headset; a second short-distance-type wireless microphone/earphone communication interface 21, for providing wireless interface between said wrist mobile phone device 1 and said wireless headset (no shown); a microphone 22, for receiving the voice message of the user and sending such message to said mobile phone device 1; an earphone 23, for outputting voice message received from said mobile phone device 1; a volume adjusting key 26, for adjusting volume of said earphone 23; and a battery, for supplying work voltage to each member.

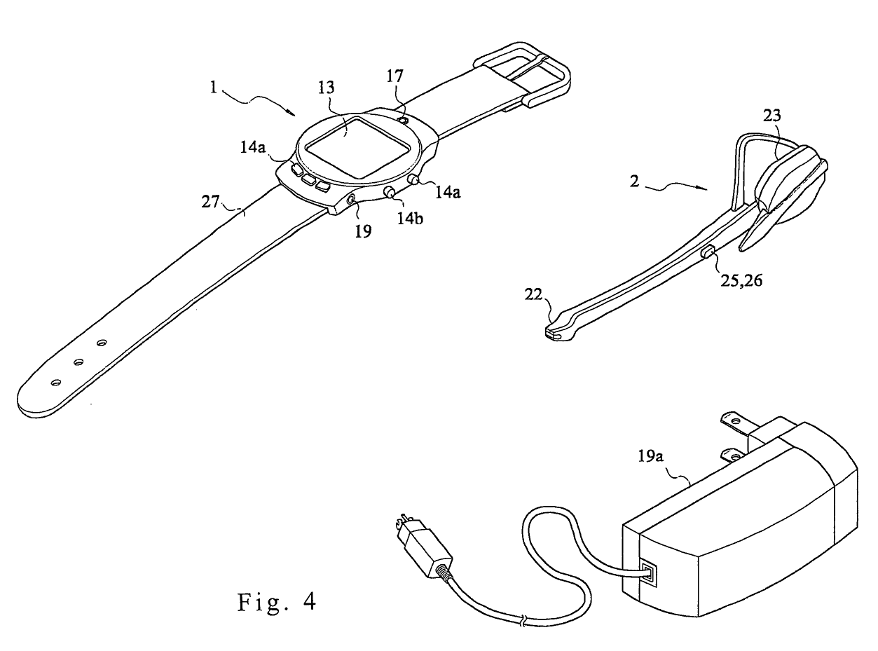

FIG. 4 is a schematic view of a product manufactured in accordance with an embodiment of present invention, in which a wrist mobile phone device 1, a wireless headset 2 and a charger accessory 19a are shown. In said wrist mobile phone device 1, only the head lens of the digital camera is shown on the upper surface of its body, however, said digital camera can also be provided on its lower surface or the side surface of the bottom to facilitate the image taking. Said wrist mobile phone device 1 is further provided with a select key 14b and a plurality of control keys 14a, in which said select key 14b may also function as a menu key while said control keys 14a may have a send key, a stop key and a scroll key except the key used to control/set the communication condition. Said charger 19a is connected via a charge interface 19 so as to charge the lithium battery of fixed or detachable design in said wrist mobile phone device 1. As shown in FIG. 4, an over-the-ear headset has a microphone 22 with a moveable arm such as stretchable or joint like arm so as to be placed as close to the mouth of user as possible and a fixed earphone 23. Said volume adjusting key 26 and power key may be integrated into one single rotation key. Since the small power consumption of said wireless headset allow us to use disposable battery to reduce the cost. Said wrist mobile phone device I is further provided with a put-on device 27 such as watchband to allow hands-free operation of such device.

However, above described is a preferred embodiment of present invention. Those who skilled in prior technique should understand that present invention is not limited to above description and various modifications and changes in accordance with claims given below are considered to fall within the spirit and scope of present invention.

List of Reference Numerals

Numeral Elements

1 wrist mobile phone device

2 wireless headset

3 mobile phone base station

10 first central processing unit (CPU)

11 memory cell

12 communication unit

13 display unit

14, 14a, 14b select/control key

15 voice identification device

16 first short-distance-type wireless microphone/earphone communication interface

17 digital camera unit

18 lithium polymer battery

19 charge interface

19a charger

20 second central processing unit

21 second short-distance-type wireless microphone/earphone communication interface

22 microphone

23 earphone

24 battery

25 power key

26 volume adjusting key

27 put-on device

What is claimed is:

1. A wrist mobile phone device comprises a mobile phone having voice activated wireless headset for conducting mobile send/receive operation of radio communication, characterized in that:
said mobile phone is provided with a put-on device so as to be put on the wrist of user, and said mobile phone is provided with a voice activated device for performing voice dial, accordingly, it is possible to provide the user with convenient mobile send/receive operation of radio communication with the aid of such wrist mobile phone device.

2. The wrist mobile phone device as set forth in claim 1, wherein said wireless headset is provided for wireless sending/receiving message to/from said mobile phone.

3. The wrist mobile phone device as set forth in claim 1, further comprises a digital camera for image taking and sending such image via said mobile phone.

4. The wrist mobile phone device as set forth in claim 1, further comprises a liquid crystal display unit for displaying images taken by said digital camera or received from external device via said mobile phone.
